(19) United States
(12) Patent Application Publication
(10) Pub. No.: US 2019/0163364 A1
(43) Pub. Date: May 30, 2019

(54) SYSTEM AND METHOD FOR TCP OFFLOAD FOR NVME OVER TCP-IP

(71) Applicant: Eidetic Communications Inc., Calgary (CA)

(72) Inventors: Sean GIBB, Calgary (CA); Stephen BATES, Canmore (CA)

(21) Appl. No.: 16/169,389

(22) Filed: Oct. 24, 2018

Related U.S. Application Data
(60) Provisional application No. 62/592,816, filed on Nov. 30, 2017.

(51) Int. Cl. G06F 3/06; H04L 29/06; G06F 13/28; G06F 13/42; H04L 12/935

(52) U.S. Cl. CPC G06F 3/061; H04L 69/161; G06F 3/0679; G06F 3/0629; H04L 2212/00; G06F 13/4282; H04L 49/30; G06F 2213/0026; G06F 13/28

(57) ABSTRACT

Systems and methods are provided for processing a non-volatile memory express over fabric (NVMe-oF) command at a Peripheral Component Interconnect Express (PCIe) attached accelerator device. Processing the NVMe-oF commands include receiving from a remote client, at a NVMe interface associated with the accelerator device, a Transport Control Protocol/Internet Protocol (TCP/IP)-encapsulated NVMe-oF command, and performing, at the accelerator device, functions associated with the NVMe-oF command that would otherwise be performed at a central processing unit (CPU).

### CROSS REFERENCE TO RELATED APPLICATIONS

This application claims the benefit of priority of U.S. Provisional Patent Application No. 62/592,816 filed Nov. 30, 2017, which is hereby incorporated by reference.

### FIELD

The present disclosure relates to controlling data acceleration including but not limited to algorithmic and data analytics acceleration.

### BACKGROUND

With the predicted end of Moore's Law, data acceleration, including algorithm and data analytics acceleration, has become a prime research topic in order to continue improving computing performance. Initially general purpose graphical processing units (GPGPU), or video cards, were the primary hardware utilized for performing algorithm acceleration. More recently, field programmable gate arrays (FPGAs) have become more popular for performing acceleration.

Typically, an FPGA is connected to a computer processing unit (CPU) via a Peripheral Component Interconnect Express (PCIe) bus with the FPGA interfacing with the CPU via drivers that are specific to the particular software and hardware platform utilized for acceleration. In a data center, cache coherent interfaces, including Coherent Accelerator Processor Interface (CAPI) and Cache Coherent Interconnect (CCIX), have been developed to address the difficulties in deploying acceleration platforms by allowing developers to circumvent the inherent difficulties associated with proprietary interfaces and drivers and to accelerate data more rapidly.

The advent of non-volatile memory (NVM), such as Flash memory, for use in storage devices has gained momentum over the last few years. NVM solid state drives (SSD) have allowed data storage and retrieval to be significantly accelerated over older spinning disk media. The development of NVM SSDs generated the need for faster interfaces between the CPU and the storage devices, leading to the advent of NVM Express (NVMe). NVMe is a logical device interface specification for accessing storage media attached via the PCI Express (PCIe) bus that provides a leaner interface for accessing the storage media versus older interfaces and is designed with the characteristics of non-volatile memory in mind.

Recently, the NVMe standard has been augmented with a network-centric variant termed NVMe over Fabrics (NVMe-oF). NVMe-oF standardizes the process for a client machine to encapsulate a NVMe command in a network frame or packet and transfer that encapsulated command across a network to a remote server to be processed. NVMe-oF facilitates remote clients accessing centralized NVM storage via standard NVMe commands and enables sharing of a common pool of storage resources over a network to a large number of simpler clients.

The Initial version of the NVMe-oF specification (1.0) defined two transports: Remote Direct Memory Access (RDMA); and Fibre-Channel (FC). Both of these transports are high performance but are not universally used in data centers.

Therefore, improvements to transport of NVMe-oF commands are desired.

### BRIEF DESCRIPTION OF THE DRAWINGS

Embodiments of the present disclosure will now be described, by way of example only, with reference to the attached Figures.

FIG. 1 is a schematic diagram of a system for processing TCP/IP-encapsulated NVMe-oF commands according to the prior art.

FIG. 2 is a schematic diagram of a system for processing TCP/IP-encapsulated NVMe-oF commands in accordance with the present disclosure;

FIG. 3 is a schematic diagram of an acceleration device in accordance with the present disclosure; and

FIG. 4 is a flow chart illustrating a method for a system for processing TCP/IP-encapsulated NVMe-oF commands in accordance with the present disclosure.

### DETAILED DESCRIPTION

The present disclosure provides systems and methods that facilitate processing Transport Control Protocol/Internet Protocol (TCP/IP)-encapsulated Non-Volatile Memory express over Fabric (NVMe-oF) commands by an accelerator device, rather than by a host central processing unit (CPU).

Embodiments of the present disclosure relate to utilizing a memory associated with the accelerator processor, such as a controller memory buffer (CMB), to store data associated with the TCP/IP-encapsulated NVMe-oF command, and perform functions associated with the TCP/IP-encapsulated NVMe-oF command based on the data stored in the memory.

In an embodiment, the present disclosure provides a method for processing a non-volatile memory express over fabric (NVMe-oF) command at a Peripheral Component Interconnect Express (PCIe) attached accelerator device that includes receiving at a NVMe interface associated with the accelerator device, from a remote client, a Transport Control Protocol/Internet Protocol (TCP/IP)-encapsulated NVMe-oF command, and performing, at the accelerator device, functions associated with the NVMe-oF command that would otherwise be performed at a host central processing unit (CPU).

In another example, the present disclosure provides an accelerator device for performing an acceleration process that includes an NMVe interface and at least one hardware accelerator in communication with the NVMe interface and configured to perform the acceleration process, wherein the NVMe interface is configured to receive, from a network interface card (NIC), a Transport Control Protocol/Internet Protocol (TCP/IP)-encapsulated NVMe-oF command, and perform, at the accelerator device, functions associated with the NVMe-oF command that would otherwise be performed at a central processing unit (CPU).

For simplicity and clarity of illustration, reference numerals may be repeated among the figures to indicate corresponding or analogous elements. Numerous details are set forth to provide an understanding of the embodiments described herein. The embodiments may be practiced without these details. In other instances, well-known methods, procedures, and components have not been described in detail to avoid obscuring the embodiments described.

The NVMe specification is a protocol that was developed in response to the need for a faster interface between computer processing units (CPUs) and solid state disks (SSDs). NVMe is a logical device interface specification for accessing storage devices connected to a CPU via a Peripheral Component Interconnect Express (PCIe) bus that provides a leaner interface for accessing the storage device versus older interfaces and was designed with the characteristics of non-volatile memory in mind. NVMe was designed solely for, and has traditionally been utilized solely for, storing and retrieving data on a storage device.

In the NVMe specification, NVMe disk access commands, such as for example read/write commands, are sent from the host CPU to the controller of the storage device using command queues. Controller administration and configuration is handled via admin queues while input/output (I/O) queues handle data management. Each NVMe command queue may include one or more submission queues and one completion queue. Commands are provided from the host CPU to the controller of the storage device via the submission queues and responses are returned to the host CPU via the completion queue.

Commands sent to the administration and I/O queues follow the same basic steps to issue and complete commands. The host CPU creates a read or write command to execute in the appropriate submission queue and then writes a tail doorbell register associated with that queue signalling to the controller that a submission entry is ready to be executed. The controller fetches the read or write command by using, for example, direct memory access (DMA) if the command resides in host memory or directly if it resides in controller memory, and executes the read or write command.

Once execution is completed for the read or write command, the controller writes a completion entry to the associated completion queue. The controller optionally generates an interrupt to the host CPU to indicate that there is a completion entry to process. The host CPU pulls and processes the completion queue entry and then writes a doorbell head register for the completion queue indicating that the completion entry has been processed.

In the NVMe specification, the read or write commands in the submission queue may be completed out of order. The memory for the queues and data to transfer to and from the controller typically resides in the host CPU's memory space; however, the NVMe specification allows for the memory of queues and data blocks to be allocated in the controller's memory space using a CMB. The NVMe standard has vendor-specific register and command space that can be used to configure an NVMe storage device with customized configuration and commands.

NVMe-oF is a network-centric augmentation of the NVMe standard in which NVMe commands at a remote client may be encapsulated and transferred across a network to a host server to access NVM storage at the host server.

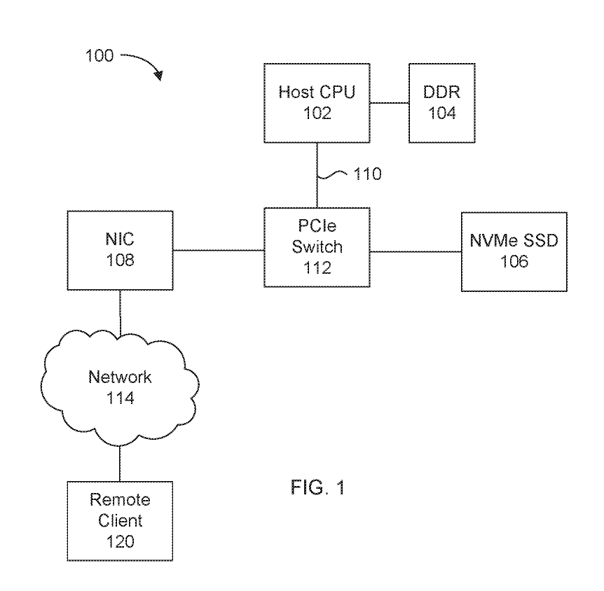

In an effort to standardize NVMe-oF, TCP/IP-encapsulation has been proposed as a standardized means of encapsulating NVMe commands. Referring to FIG. 1, a traditional system 100 for receiving and processing TCP/IP-encapsulated NVMe-oF commands is shown. The system 100 includes a host CPU 102. The host CPU 102 may have an associated double data rate memory (DDR) 104, which may be utilized to establish NVMe queues for NVMe devices.

The host CPU 102 is connected to an NVMe SSD 106 and a network interface card (NIC) via a PCIe bus 110. A PCIe switch 112 facilitates switching the PCIe bus 110 of the host CPU 102 between the NVMe SSD 106 and the NIC 108. The NIC 508 connects, via a network 114, the host CPU 102 and NVMe SSD 106 with a remote client 120.

In operation, the remote client 120, which wishes to access storage in the NVMe SSD 106, generates an encapsulated NVMe-oF command. The encapsulated NVMe-oF command is transmitted by the remote client 120 to the host CPU 102 via the network 114 and the NIC 108.

The NIC 108 passes the encapsulated NVMe-oF command to the host CPU 102. The host CPU 102 then performs processing on the encapsulated NVMe-oF command to remove encapsulation and obtain the NVMe-oF command. The host CPU 102 then issues a command to the NVMe SSD 106 to perform the function associated with NVMe command. The function may be, for example, reading from or writing data to the NVMe SSD 106.

The encapsulated NVMe command transmitted by the remote client 120 may be encapsulated utilizing, for example, remote direct memory access (RDMA). A benefit of utilizing RDMA for transport of NVMe-oF commands is that is that the data passed in or out of the NIC 108 by direct memory access (DMA) is, and only is, the data needed to perform the NVMe command, which may be the command itself or the data associated with the command. Thus, RDMA is useful in a Peer-2-Peer (P2P) framework because no network-related post processing of the data in or out of the NIC 108 is performed.

In another example, the encapsulated NVMe-oF command transmitted by the remote client 120 may be encapsulated utilizing TCP/IP. In TCP/IP, generally the data that is passed in or out of the NIC 108 also includes other data that is associated with, for example, the network stack. Often some kind of buffer may be used, such as a range of contiguous system memory, as both a DMA target for the NIC 108 and a post-processing scratchpad for the host CPU 102. The host CPU 102 may perform TCP/IP tasks such as, for example, evaluating TCP/IP Cyclic Redundancy Checks (CRCs) and Checksums to identify data integrity issues, determining which process/remote client 120 is requesting the data based on the flow IDs, and checking for forwarding rules, firewall rules, etc. based on the TCP/IP addresses.

However, a problem with traditional system 100 is that having the host CPU 102 perform these tasks in the context of TCP/IP-encapsulated NMVe-oF commands may be computationally intensive, which may in a “noisy neighbour” issue in which the DMA traffic and TCP/IP processing at the host CPU 102 impacts memory accesses and scheduling times for other processes running on the host CPU 102.

In the present disclosure, TCP/IP-encapsulated NVMe-oF commands are sent to an accelerator device for processing, rather than to the host CPU, in order to redirect DMA traffic away from the host CPU and reduce the “noisy neighbour” issue of the prior art system 100.

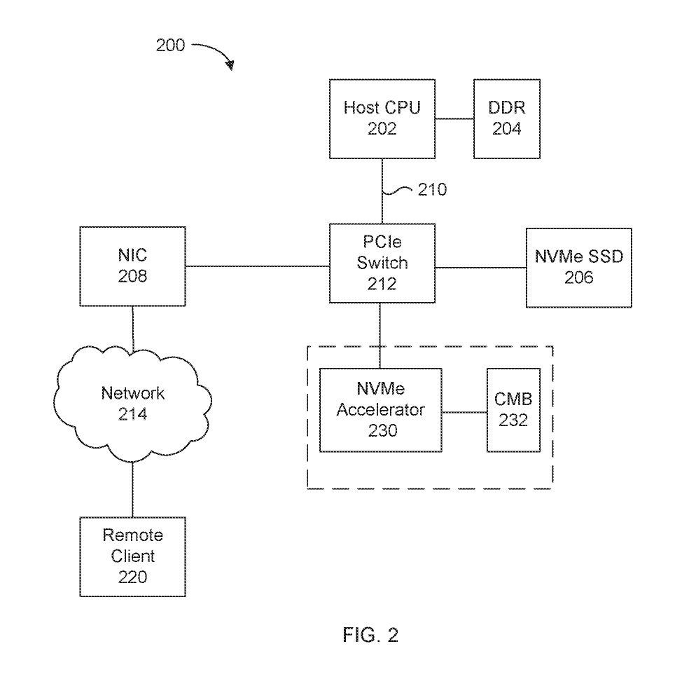

Referring now to FIG. 2, a schematic diagram of an example of a system 200 in which TCP/IP-encapsulated NVME-oF commands are processed by an accelerator device rather than a host CPU is shown. The system 200 includes a host CPU 202, a DDR 204 associated with the host CPU 202, a NVMe SSD 206 and a NIC 208 connected to the host CPU 204 via a PCIe bus 210 and a PCIe switch 212. The NIC 208 connects the host CPU 204 and the NVMe SSD 206 to a remote client 220 via a network 214. The host CPU 202, DDR 204, NVMe SSD 206, NIC 208, PCIe bus 210, PCIe switch 212, network 214, and remote client 220 may be substantially similar to the host CPU 102, DDR 104, NVMe SSD 106, NIC 108, PCIe bus 110, PCIe switch 112, network 114, and remote client 120 described with reference to FIG. 1 and therefore are not further described here to avoid repetition.

The host CPU 202, NVMe SSD 206, and NIC 208 are also connected to an accelerator device 230 via the PCIe switch 212. The accelerator device 230 may have an associated Control Memory Buffer (CMB) 232.

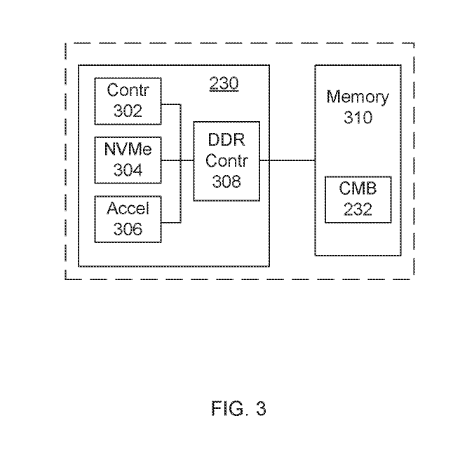

FIG. 3 shows schematic diagram of an example of the components of the accelerator device 230. In the example shown, the accelerator device 230 includes a controller 302, which includes a DMA engine, an NVMe interface 414, one or more hardware accelerators 304, and a DDR controller 408. The CMB 232 associated with the accelerator device 230 may be included within a memory 310 associated with the accelerator device 230.

Referring back to FIG. 2, a TCP/IP-encapsulated NVMe-oF command is generated and transmitted by the remote client 220 to the NIC 208 via the network 214. Rather than sending the received TCP/IP-encapsulated NVMe-oF command to the host CPU 202, as in the traditional system 100, the NIC 208 of the system 200 sends the received TCP/IP-encapsulated NVMe-oF command to the accelerator device 230 for processing. The TCP/IP-encapsulated NVMe-oF command may be received by, for example, a NVMe interface 304 of the accelerator device 230. The accelerator device 230 then performs processing of the TCP/IP-encapsulated NVMe-oF command. Processing may include removing the TCP/IP encapsulation to obtain the NVMe-oF command, as well as performing a function associated with the NVMe-oF command. The function may be performed on data associated with the NVMe-oF command. Data associated with the NVMe-oF command may be data transmitted as part of, or together with, the TCP/IP-encapsulated NVMe-oF command, or may be data stored at a memory device, such as the NVMe SSD 206, that is referenced by the TCP/IP-encapsulated NVMe-oF command.

The CMB 232 associated with the accelerator device 230 may be utilized as a buffer for the TCP/IP traffic, such as for example a buffer for tasks associated with the TCP/IP-encapsulated NVMe-oF command. For example, data associated with the NVMe-oF command may be transmitted to and stored in the CMB 232. Data may be stored in the CMB 232 by, for example, performing a DMA for all data associated with the TCP/IP-encapsulated NVMe-oF command from, for example, the NVMe SSD 206 and store the data to the CMB 232.

The accelerator device 230 may then perform functions on the data stored in the CMB 232, including, but not limited to, the above-described TCP/IP related tasks of evaluating TCP/IP CRCs and Checksums to identify data integrity issues, determining which process/remote client 220 is requesting the data based on the flow IDs, and checking for forwarding rules, firewall rules, etc. based on the TCP/IP addresses.

Additionally, the accelerator device 230 may perform other data operation functions on the data associated with the NVMe-oF command, such as data that is stored in the CMB 232 or data referenced by the NMVe-oF command that is stored at a peripheral memory device such as NVMe SSD 206. Data operation functions include, but are not limited to, compression, searching, and error protection functions.

In an example, the NVMe-oF commands associated with these other data operation functions may have the form of standard NVMe disk access commands included in the NVMe specification, but the standard NVMe disk access commands are utilized by the acceleration device 230 as acceleration commands not disk access commands. The user of standard NVMe disk access commands being utilized as acceleration commands rather than disk access commands is more fully described in U.S. Provisional Patent Application No. 62/500,794, which is incorporated herein by reference.

In an example, if the accelerator device 230 includes multiple hardware accelerators 306, each hardware accelerator 306 may be associated with respective NVMe namespaces. For example, the NVMe namespaces may be, for example, logical block addresses that would otherwise have been associated with an SSD. In this example, the accelerator device 230 is unassociated with an SSD and the disk access commands included in the TCP/IP-encapsulated NVMe-oF command are sent in relation to an NVMe namespace that would otherwise have been associated with an SSD, but is instead used to enable hardware acceleration, and in some cases a specific type of hardware acceleration.

When the accelerator device 230 has finished all processing of the data associated with the TCP/IP-encapsulated NVMe-oF command, the accelerator device 230 may send an indication to the host CPU 202 indicating that processing is complete. The indication may include the result data generated by the processing performed by the accelerator device 230. Alternatively, the accelerator device 230 may store the result data in a memory location and the indication send to the host CPU 202 may include a Scatter Gather List (SGL) that indicates the memory location where the result data is stored. The data storage location of the result data may be different than the data storage location of data associated with the NVMe-oF command. Alternatively, the result data may be stored at the same data storage location and overwrite the data associated with the NVMe-oF command. The data storage location of the result data may be, for example, a location within the CMB 232 that is different than the information associated with the NVMe-oF command, a location in a memory associated with the host CPU, such as the DDR 204, or a location within a PCIe connected memory such as NVMe SSD 206.

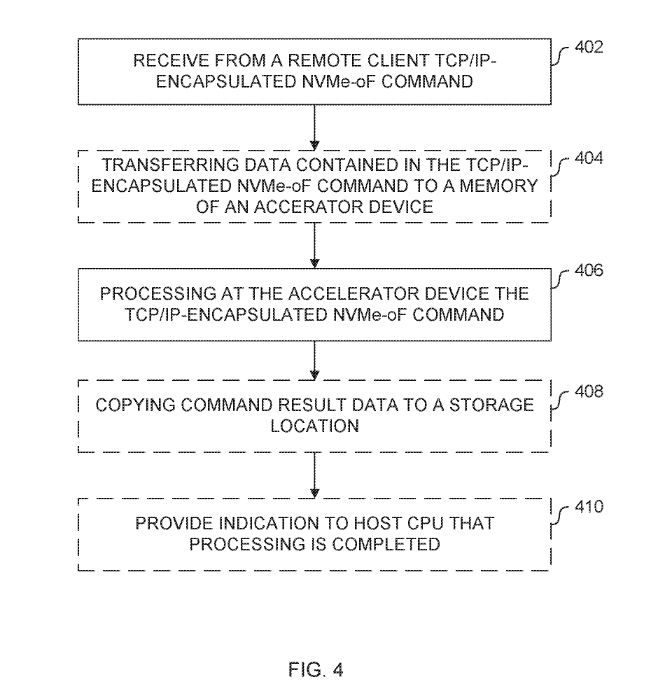

Referring now to FIG. 4, flow chart illustrating a method of processing TCP/IP-encapsulated NVMe-oF commands by an accelerator device, rather than at a host CPU, is shown. The method may be implemented in the example system 200 described above. The method may be performed by, for example, a processor of an NVMe accelerator that performs instructions stored in a memory of the NVMe accelerator.

At 402, a TCP/IP-encapsulated NVMe-oF command is received from a remote client. The TCP/IP-encapsulated NVMe-oF command may be received at, for example, a NVMe interface of an accelerator device, such as the NVMe interface 304 of the accelerator device 230. The TCP/IP-encapsulated NVMe-oF command may be generated at the remote client by, for example, obtaining an initial NVMe-oF command and encapsulating the initial NVMe command utilizing the TCP/IP standard. As described above, the TCP/IP-encapsulated NVMe-oF command may in the form of a standard NVMe disk access command, but the standard NVMe disk access command is utilized by the acceleration device as an acceleration command and not as a disk access command.

Optionally, at 404, data associated with the TCP/IP-encapsulated NVMe-oF command is stored in a memory associated with the accelerator device 230. The data associated with the TCP/IP-encapsulated NVMe-oF command may be data sent with the TCP/IP-encapsulated NVMe-oF command, or may be data stored elsewhere such as, for example, a PCIe connected memory such as the NVMe SSD 206. The memory associated with the accelerator device may be, for example, the CMB 232.

At 406, the accelerator device processes the TCP/IP-encapsulated NVMe-oF command. Processing the TCP/IP-encapsulated NVMe-oF command may include removing the TCP/IP encapsulation and performing a function associated with the NVMe command. As described above, functions performed may include TCP/IP related tasks such as, for example, evaluating TCP/IP CRCs and Checksums to identify data integrity issues, determining which process/remote client 220 is requesting the data based on the flow IDs, and checking for forwarding rules, firewall rules, etc. based on the TCP/IP addresses. Additionally, performing functions associated with the NVMe-oF command may include performing other data operation functions typically performed by a hardware accelerator such as, for example, compression, searching, and error protection functions. The other data operation functions may be performed in response to the acceleration device receiving a TCP/IP-encapsulated NVMe-oF in the form of a standard NVMe disk access command, but the standard NVMe disk access command is utilized by the acceleration device as an acceleration command to perform the other data operation and not as a disk access command.

Optionally, at 408, result data generated from the processing performed by the acceleration device at 406 may be stored to a storage location. The storage location may be different than the storage location of the data associated with the TCP/IP-encapsulated NVMe-oF command that is optionally stored at 404. Alternatively, the result data may be stored at the same storage location and overwrite the data associated with the TCP/IP-encapsulated NVMe-oF command that is optionally stored at 404. The storage location may be, for example, a location within the CMB that is different than the location where information associated with the NVMe-oF command is optionally stored at 404, a location in a memory associated with the host CPU, such as the DDR 204, or a location within a PCIe connected memory such as NVMe SSD 206.

Optionally at 410, the acceleration device may provide an indication to the CPU that the processing of the TCP/IP-encapsulated NVMe-oF command is completed. As set out above, the indication may include the result data generated by the processing performed by the accelerator device. Alternatively, if the accelerator device 230 has stored the result data in a memory location at 408, the indication may include the memory location at which the result is stored. For example, the acceleration device may send the host CPU a SGL that indicates the memory location where the result data is stored.

The present disclosure provides a system and method for processing TCP/IP-encapsulated NVMe-oF commands at an acceleration device, rather than at a host CPU. Processing by the acceleration device may include performing TCP/IP tasks as well as other data operations typically performed by a hardware accelerator. Data related to the TCP/IP-encapsulated NVMe-oF command may be stored in a memory associated with the acceleration device, such as a CMB, and storing the data results generated from processing the TCP/IP-encapsulated NVMe-oF command in a different memory location. The acceleration device may send an indication to the host CPU indicating that the processing of the TCP/IP-encapsulated NVMe-oF command is completed. The indication may include the result data or may include the memory location of the result data in, for example, a GSL.

Advantageously, by sending all DMA traffic between the accelerator device, including CMB, and the NIC, the demands on the memory system, i.e., the host CPU and the PCIe connected memory device, are reduced. This reduces demands on the host CPU processing and memory bandwidth of the host CPU utilized by TCP/IP-encapsulated NVMe-oF. This also reduces the DDR-related demands on the host CPU. As a result, the host CPU is freed up for other processes running on the host CPU, which may increase memory access and shorten scheduling times.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for processing a non-volatile memory express over fabric (NVMe-oF) command at a Peripheral Component Interconnect Express (PCIe) attached accelerator device, the method comprising:
receiving at a NVMe interface associated with the accelerator device, from a remote client, a Transport Control Protocol/Internet Protocol (TCP/IP)-encapsulated NVMe-oF command;
performing, at the accelerator device, functions associated with the NVMe-oF command that would otherwise be performed at a host central processing unit (CPU).

2. The method of claim 1 further comprising:
transferring data associated with in the TCP/IP-encapsulated NVMe-oF command to a first data storage location within a memory associated with the accelerator device,
wherein the functions associated with the NVME-oF command are performed based on the data transferred to the memory.

3. The method of claim 2 wherein the memory comprises a controller memory buffer (CMB) associated with the accelerator device, the CMB acting as a buffer for tasks related to the TCP/IP-encapsulated NVMe-oF command.

4. The method of claim 3 further comprising:
copying result data to a second data storage location, the second data storage location being one of a location within the CMB, a location in a memory associated with the host CPU, or a location in a PCIe connected memory device.

5. The method of claim 4 further comprising:
providing a Scatter Gather List (SGL) to the host CPU informing of the second data storage location.

6. The method of claim 1 further comprising:
generating, at the remote client, the TCP/IP-encapsulated NVMe-oF command.

7. The method of claim 6 wherein generating the TCP/IP-encapsulated NVMe-oF command further comprises:
obtaining an initial NVMe-oF command; and
encapsulating the initial NVME-oF command using TCP/IP, to create the TCP/IP-encapsulated NVMe-oF command.

8. The method of claim 1 wherein:
the NVMe interface associated with the accelerator device is unassociated with a solid state drive; and
the TCP/IP-encapsulated NVMe-oF command has a format of a disk read or write function but is unrelated to a disk read or write function.

9. An accelerator device for performing an acceleration process, the accelerator device comprising:
an NMVe interface and at least one hardware accelerator in communication with the NVMe interface and configured to perform the acceleration process, wherein the NVMe interface is configured to:
receive, from a remote client, a Transport Control Protocol/Internet Protocol (TCP/IP)-encapsulated NVMe-oF command;
perform, at the accelerator device, functions associated with the NVMe-oF command that would otherwise be performed at a host central processing unit (CPU).

10. The accelerator device of claim 9, wherein the NVMe interface is further configured to:
transfer data associated with the TCP/IP-encapsulated NVMe-oF command to first data storage location within a memory associated with the accelerator device,
wherein the functions associated with the NVME-oF command are performed based on the data transferred to the memory.

11. The accelerator device of claim 10, further comprising a control memory buffer (CMB), wherein transferring data associated with the TCP/IP-encapsulated NVMe-oF command comprises transferring data associated with the TCP/IP-encapsulated NVMe-oF command to the CMB.

12. The accelerator device of claim 9, wherein the NVMe interface is further configured to:
copy result data to a second data storage location, the second data storage location being one of a location within the CMB, a location in a memory associated with the host CPU, or a location in a Peripheral Component Interconnect Express (PCIe) connected memory device.

13. The accelerator device of claim 12, wherein the NVMe interface is further configured to provide a Scatter Gather List (SGL) to the host CPU informing of the second data storage location.

14. The accelerator device of claim 9, wherein the NVMe interface is further configured to:
determine, that the hardware accelerator has completed performing the function; and
send to the host CPU a NVMe an indication indicating that the function has been performed.
